(19) United States
(12) Patent Application Publication
(10) Pub. No.: US 2004/0075002 A1
(43) Pub. Date: Apr. 22, 2004

(54) Fuel injection valve

(76) Inventors: Volker Holzgrefe, Ditzingen (DE); Guenther Hohl, Stuttgart (DE); Michael Huebel, Gerlingen (DE); Juergen Stein, Illingen (DE)

Correspondence Address: KENYON & KENYON, ONE BROADWAY, NEW YORK, NY, 10004, US

(21) Appl. No.: 10/451,556

(22) PCT Filed: Aug. 22, 2002
(86) PCT No.: PCT/DE02/03072

(30) Foreign Application Priority Data
Oct. 24, 2001 (DE) 101 52 416.1

(51) Int. Cl. B05B 1/30

(52) U.S. Cl. 239/585.1

(57) ABSTRACT

A fuel injector (1) for the direct injection of fuel into the combustion chamber of an internal combustion engine includes a valve needle (4) situated in a nozzle body (3), the valve needle (4) being actuable by an actuator (7) and acted upon by a restoring spring (9) in such a manner that a valve-closure member (5) which is in operative connection to the valve needle (4) and faces the combustion chamber is kept in sealing contact to a valve-seat surface (6) in the non-actuated state of the actuator (7). A first jet-opening angle α₁ is assigned to a first lift state of the valve needle (4) and a second jet-opening angle α₂ to a second lift state of the valve needle (4).

### BACKGROUND INFORMATION

The present invention is directed to a fuel injector of the type set forth in the main claim.

For instance, from DE 195 34 445 A1, an outwardly opening fuel injector is known which has a conical sealing seat. The valve needle has a central bore which leads into a pressure chamber upstream from the sealing seat. An actuator, which is embodied as a piezoelectric actuator, is braced against a nozzle body on the one side and against a pressure shoulder, which is connected to the valve needle by force-locking, on the other side. A restoring spring keeps the valve needle in a closing position. In response to the actuator being energized, the valve needle, due to the actuator's longitudinal extension, is opened against the closing force of the restoring spring and fuel is spray-discharged.

Disadvantageous in the fuel injector known from DE 195 34 445 A1 is, in particular, that the fuel jet injected into the combustion chamber of the internal combustion engine has a conical shape and a particular opening angle α. An injection at different opening angles α, which takes into account, for example, the various demands on the form of the mixture cloud in the partial load and full load range, is not possible here.

### SUMMARY OF THE INVENTION

In contrast, the fuel injector according to the present invention having the characterizing features of the main claim has the advantage over the related art that, depending on the lift position of the valve needle, a larger or smaller spray-opening angle is representable, which may be selected in accordance with the operating state of the internal combustion engine.

Advantageous further developments of the fuel injector specified in the main claim are rendered possible by the measures elucidated in the dependent claims.

This may advantageously be realized by an easily producable geometry of the end of the fuel injector adjacent to the sealing seat. For this purpose, an inclined region, whose angle of inclination deviates from that of the valve-seat surface, is formed adjacent to the valve-seat surface.

It is also advantageous that by an appropriate form of the downstream-side end of the fuel injector and, correspondingly, by an appropriate design of the valve-closure member, any desired jet angle is able to be realized.

### BRIEF DESCRIPTION OF THE DRAWINGS

An exemplary embodiment of the present invention is represented in the drawing in simplified form and explained in greater detail in the following description.

The figures show:

FIG. 1 a schematic section through an exemplary embodiment of a fuel injector configured according to the present invention, in a first lift position; and

FIG. 2 a schematic section through an exemplary embodiment of a fuel injector configured according to the present invention, in a second lift position.

### DESCRIPTION OF THE EXEMPLARY EMBODIMENT

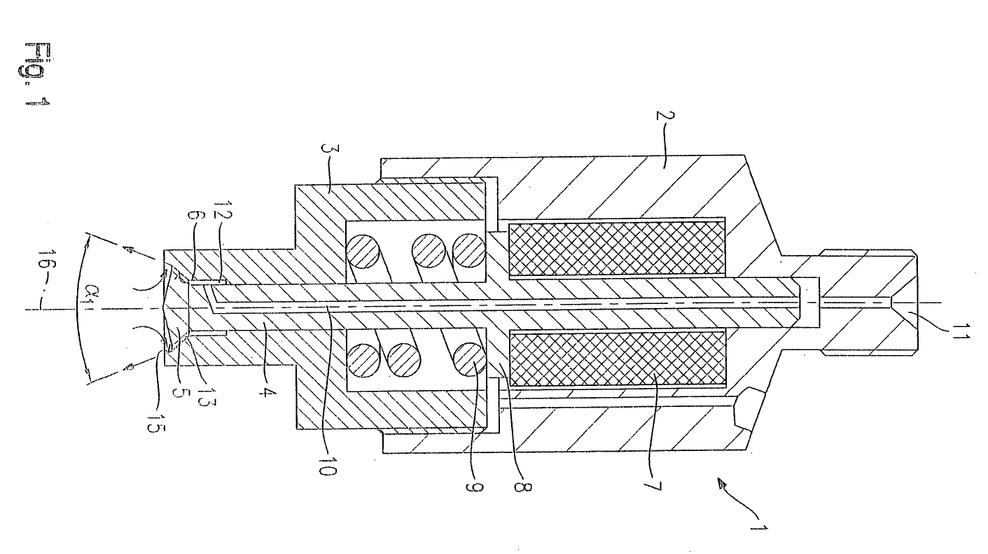

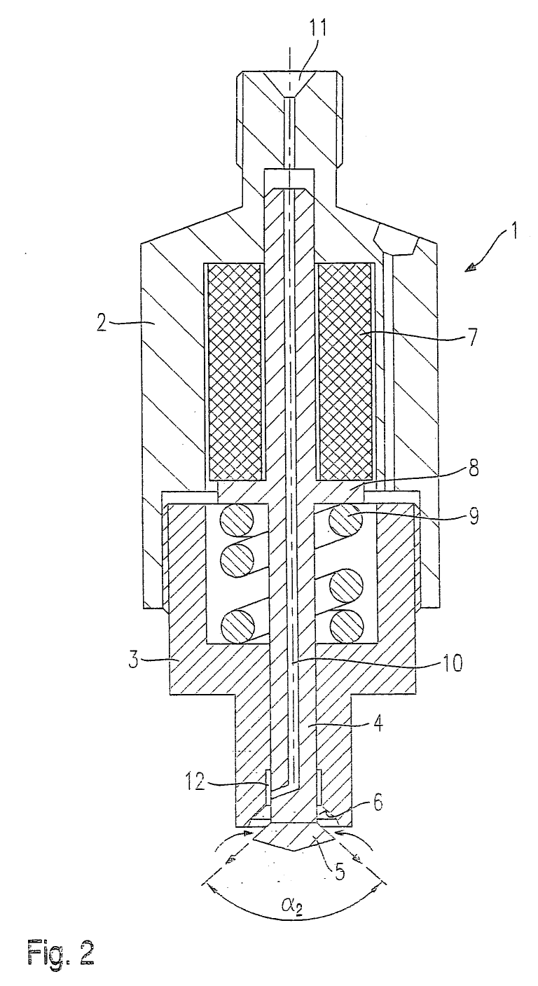

An exemplary embodiment of a fuel injector 1 according to the present invention, shown in two different lift states in FIGS. 1 and 2, is designed in the form of a fuel injector 1 for fuel-injection systems of mixture-compressing internal combustion engines having externally supplied ignition. Fuel injector 1 is particularly suited for the direct injection of fuel into a combustion chamber (not shown) of an internal combustion engine.

Fuel injector 1 includes a housing body 2 and a nozzle body 3, in which a valve needle 4 is positioned. Valve needle 4 is in operative connection to a valve-closure member 5 which cooperates with a valve-seat surface 6 to form a sealing seat. The fuel injector in the exemplary embodiment is an outwardly opening fuel injector 1. It includes an actuator 7 which is embodied as a piezoelectric actuator 7 in the exemplary embodiment. The actuator is braced on one side on housing body 2, and on the other side on a shoulder 8 which is in operative connection to valve needle 4. Downstream from shoulder 8 is a restoring spring 9 which in turn is braced on nozzle body 3.

Valve needle 4 has a fuel channel 10 through which the fuel, conveyed through a central fuel feed 11 on the inflow side, is guided to the sealing seat. On the inflow side of the sealing seat, a swirl chamber 12 is formed into which fuel channel 10 opens.

In the rest state of fuel injector 1, shoulder 8 is acted upon by the force of restoring spring 9, against the lift direction, in such a way that valve-closure member 5 is held in sealing contact on valve-seat surface 6. In response to piezoelectric actuator 7 being energized, it expands in the axial direction, counter to the spring force of restoring spring 9, so that shoulder 8 with valve needle 4, which is joined to shoulder 8 by force-locking, is moved in the lift direction. Valve-closure member 5 lifts off from valve-seat surface 6, and the fuel conveyed via fuel channel 10 is spray-discharged.

When the piezoelectric actuator is discharged, the axial extension of piezoelectric actuator 7 is reduced, so that valve needle 4, due to the pressure of restoring spring 9, is moved counter to the lift direction. Valve closure member 5 comes to rest on valve-seat surface 6, and fuel injector 1 is closed.

In partial-load operation, a mixture-compressing internal combustion engine having external ignition places different demands on the form, stoichiometry and penetration capability of the mixture cloud injected into the combustion chamber than it does in full-load operation. In partial-load operation, the mixture cloud, as shown in FIG. 1, should have a relatively small opening angle α, high penetration capability, a small core region, due to the small opening angle α₁, with a fatter mixture, and a very lean envelope. In contrast, in full-load operation, as shown in FIG. 2, a large opening angle α₂ and, thus, a nearly homogenous charge of the cylinder with ignitable mixture is required.

In order to take these requirements on the mixture formation into account, two lift states are defined for fuel injector 1 according to the present invention, thereby making it possible during operation to represent various jet patterns which may be selected in accordance with the operating state of the internal combustion engine.

FIG. 1 shows fuel injector 1 in a first lift state. Valve-closure member 5 has already lifted off from valve-seat surface 6, but only releases a narrow gap 13 between valve-closure member 5 and valve-seat surface 6. Due to the geometry of the downstream end 14 of fuel injector 1 which, in an inclined region 15 downstream from valve-seat surface 6, has less of an incline relative to a longitudinal axis 16 of fuel injector 1 than valve-seat surface 6, the fuel jet spray-discharged from gap 13 in the first lift state, which is shown in FIG. 1, is tangential to the inclined region 15 of downstream end 14 of fuel injector 1 because of the entrainment of the flow in the interior of the fuel jet. This makes it possible to represent a fuel jet having a small opening angle α₁ which has the high penetration capability required in stratified operation.

FIG. 2 shows a second lift position of fuel injector 1. Here, valve-closure member 5 has shifted further away from valve-seat surface 6, so that gap 13 is wider than in FIG. 1. Due to the entrainment of the flow on the outside of the injection jet of gap 13, the spray-discharged fuel jet is now tangential to valve-closure member 5 which has a large incline relative to longitudinal axis 16 of fuel injector 1, thus resulting in a considerable widening of the fuel jet. Therefore, opening angle α₂ is enlarged when compared to the first lift position, which is advantageous for full-load range of the internal combustion engine since the entire combustion chamber is filled with a relatively homogenous stoichiometric mixture.

The various lift positions of valve needle 4 may be actuated in a simple manner, for instance, by using two separately actuable actuators 7. These may be, for instance, a voltage-regulated or voltage-controlled piezoactuator and two piezoelectric actuators 7 which are controlled in succession. The use of two magnetic circuits having two separate coils, or a bipartite magnetic armature is also conceivable.

By a suitable selection of the inclines of valve-seat surface 6 or of valve-closure member 5 and inclined region 15, jet angles α₁ and α₂ may be selected in such a way that the combustion chamber of the internal combustion engine is able to be filled with an ignitable fuel-air mixture in an optimal manner. Inclined region 15 and valve-seat surface 6 may be produced, for instance, during the manufacture of nozzle body 3, by turning on a lathe, for example.

The present invention is not limited to the exemplary embodiment shown, but may also be applied to arbitrary configurations of fuel injectors 1 having any number of actuators 7.

What is claimed is:

1. A fuel injector (1) for the direct injection of fuel into the combustion chamber of an internal combustion engine, having a valve needle (4) situated in a nozzle body (3), the valve needle (4) being actuable by an actuator (7) and acted upon by a restoring spring (9) in such a manner that a valve-closure member (5) that is in operative connection to the valve needle (4) and faces the combustion chamber is kept in sealing contact to a valve-seat surface (6) in the non-actuated state of the actuator (7),
wherein a first jet-opening angle α₁ is assigned to a first lift state of the valve needle (4) and a second jet-opening angle a2 to a second lift state of the valve needle (4).

2. The fuel injector as recited in claim 1,
wherein a first valve-needle lift corresponding to the first lift state is smaller than a second valve-needle lift corresponding to the second lift state.

3. The fuel injector as recited in claim 2,
wherein α₁ is smaller than α₂.

4. The fuel injector according to one of claims 1 through 3,
wherein, at a downstream end (13) of the fuel injector (1), an inclined region (15) is formed adjacent to the valve-seat surface (6).

5. The fuel injector as recited in claim 4,
wherein the inclined region (15), relative to a longitudinal axis (16) of the fuel injector (1), is less strongly inclined than the valve-seat surface (6).

6. The fuel injector as recited in claim 5,
wherein the opening angle α₁ relative to the longitudinal axis (16) of the fuel injector (1), is double the angle of inclination of the inclined region (15).

7. The fuel injector as recited in claim 5,
wherein the opening angle α₂, relative to the longitudinal axis (16) of the fuel injector (1), is double the angle of inclination of the valve-seat surface (6).
